(19) United States
(12) Patent Application Publication
(10) Pub. No.: US 2008/0211978 A1
(43) Pub. Date: Sep. 4, 2008

(54) Controlling Shape and Direction of Light

(75) Inventors: Rifat Ata Mustafa Hikmet, Eindhoven (NL); Johannes Petrus Maria Ansems, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/994,589

(22) PCT Filed: Jul. 6, 2006
(86) PCT No.: PCT/IB2006/052275

§ 371 Date: Jan. 3, 2008

(30) Foreign Application Priority Data
Jul. 8, 2005 (EP) 05106256.0

(51) Int. Cl. G02F 1/13; G02F 1/1333

(52) U.S. Cl. 349/33; 349/139; 349/69

(57) ABSTRACT

A device (201) for controlling shape and direction of light, comprises a first transparent planar substrate (203) and a second transparent planar substrate (205), the substrates being configured for arrangement essentially perpendicular to incident light beams (211), a liquid crystal layer (209) arranged between the first and second substrate, a first transparent electrode pattern (207) arranged on the first substrate and a second transparent electrode pattern (217) arranged on the second substrate, and control means configured to adjust an electric potential difference between the first and second electrode patterns, thereby configured to adjust a refractive index of the liquid crystal layer.

The present invention relates to a device for controlling shape and direction of light as well as a lighting system comprising such a device.

In display and illumination applications today there exists a need to control the emission of light. This need applies both in terms of the direction in which light is emitted as well as in terms of the spatial distribution of the emitted light, for example the shape of a light beam.

The state of the art in the field includes U.S. Pat. No. 5,122,888 in which a focusing plate for a camera is described.

A drawback related to the device that is described in U.S. Pat. No. 5,122,888 is that it is not capable of controlling shape and direction of light.

An object of the present invention is hence to overcome drawbacks related to prior art.

The object is achieved by way of devices and a system according to the appended claims.

That is, a device for controlling shape and direction of light, comprises:
a first transparent planar substrate and a second transparent planar substrate, the substrates being configured for arrangement essentially perpendicular to incident light beams,
a liquid crystal layer arranged between the first and second substrate,
a first transparent electrode pattern arranged on the first substrate and a second transparent electrode pattern arranged on the second substrate, and
control means configured to adjust an electric potential difference between the first and second electrode patterns, thereby configured to adjust a refractive index of the liquid crystal layer.

Preferably, the potential difference is controlled in accordance with an AC frequency.

An advantage of the invention is that it overcomes the problems related to prior art devices, while avoiding loss of light during the control of beam shape and direction.

Embodiments of the invention include such a realization where the first electrode pattern is essentially identical to the second electrode pattern. Moreover, any of the first electrode pattern and the second electrode pattern may comprise a plurality of hexagonal features.

The electrode patterns may in some embodiments comprise a plurality of electrode segments, each segment being configured to be individually adjusted with respect to electric potential.

Any one of the first electrode pattern and the second electrode pattern may also be substantially featureless.

It is also possible to arrange a layer of conductor on top of patterned electrodes, the layer having a high surface resistance in the order of MΩ/square.

The electrode patterns may comprise features of spatial dimensions essentially in the interval 1-10 μm and may comprise features in the range of 10-100 μm in the areas with no high surface resistance. The first substrate and the second substrate may be separated by a distance in the interval 5-50 μm.

One preferred choice of material for the electrodes is Indium Tin Oxide (ITO).

The embodiments include a controller that is configured to adjust the electric potential difference between the first and second electrode patterns in the interval 0-20V(rms).

In one embodiment, a device for controlling shape and direction of light comprises a first device as described above in which the liquid crystal material is aligned along a first direction of orientation, and a second such device in which the liquid crystal material is aligned along a second direction of orientation.

The first direction of orientation may be essentially perpendicular to said second direction of orientation and also be essentially parallel to said second direction of orientation. In such a case, where the orientations are parallel, the device further comprises a half wave plate arranged between said first and second devices.

Preferably, the first and the second devices are arranged so as to avoid appearance of local maxima and minima in the intensity of transmitted light.

An advantage of such embodiments is that it provides for efficient control of light beams that comprises polarized light. Essentially no light is allowed to pass through such a device without being controlled.

In another aspect, the object is achieved by way of a lighting system comprising a device as described above and a light source.

Embodiments of the invention will now be described with reference to the accompanying drawings.

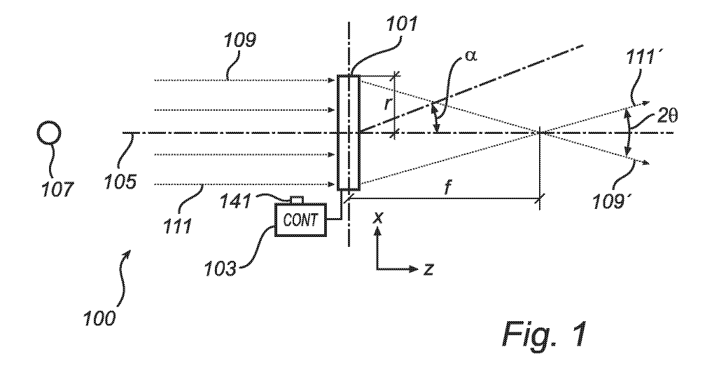

FIG. 1 is a schematically illustrated system according to the present invention.

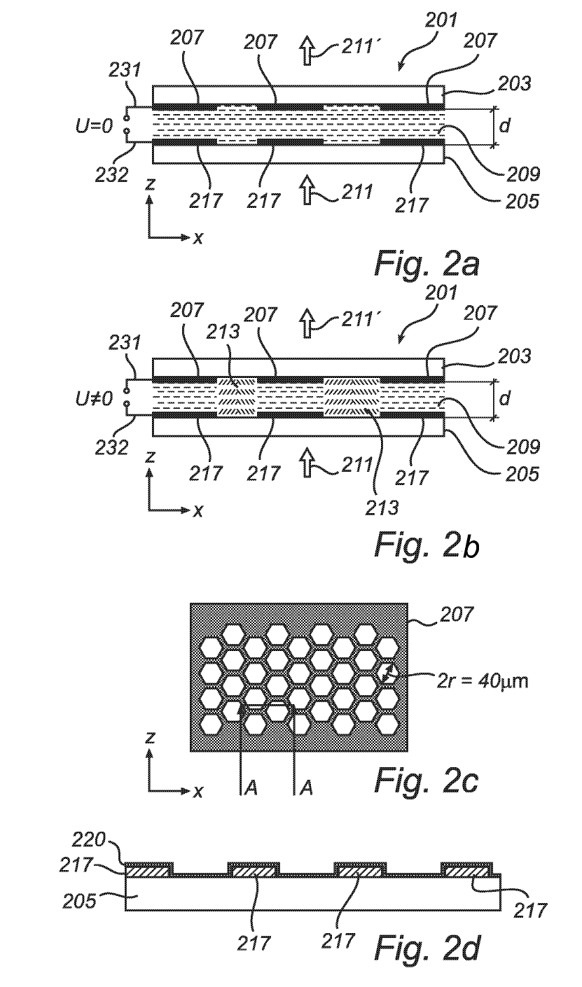

FIGS. 2a and 2b are schematically illustrated cross sectional views of a device according to the present invention.

FIG. 2c is a schematically illustrated top view of the device of FIGS. 2a and 2b.

FIG. 2d schematically shows a cross section of an electrode pattern covered with a layer having a high surface resistance.

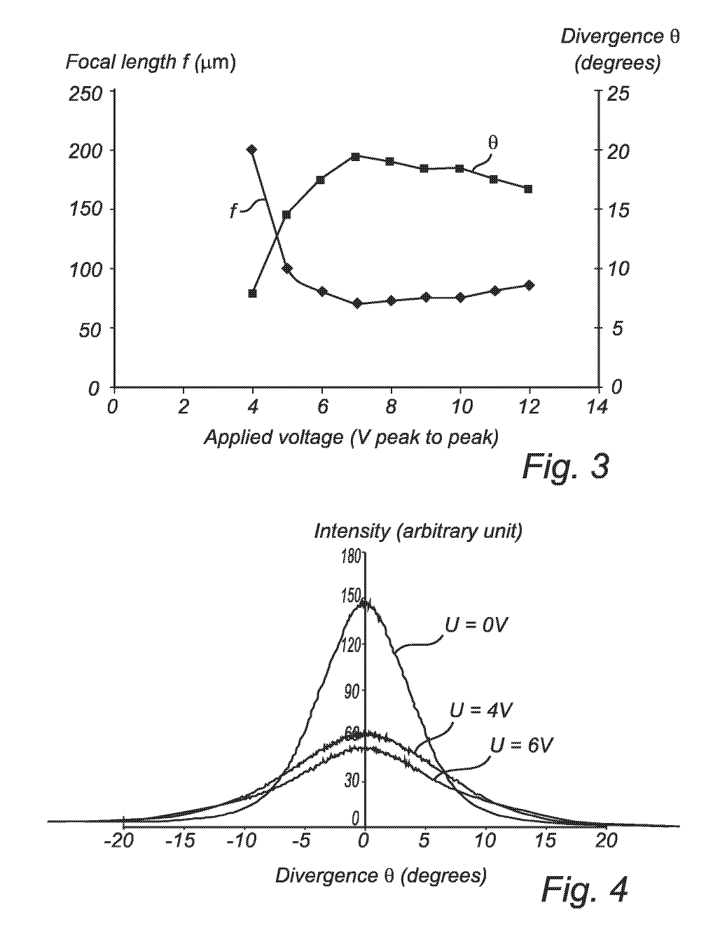

FIGS. 3 and 4 are diagram that illustrate experimental results relating to a device according to the present invention.

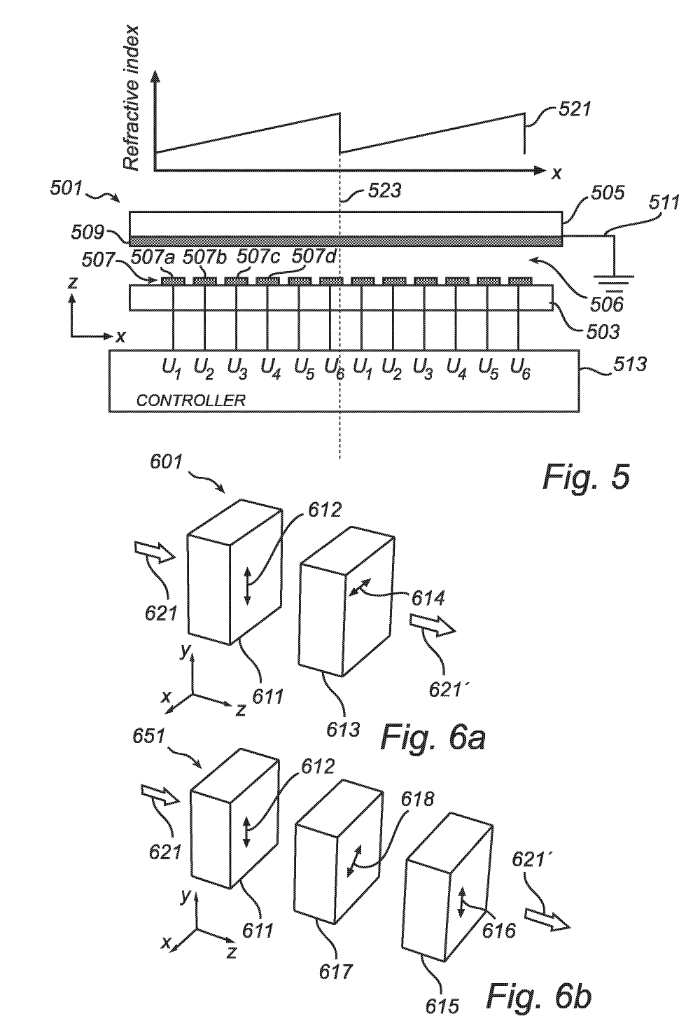

FIG. 5 is a schematically illustrated cross sectional view, together with a schematically illustrated diagram of the distribution of refractive index, of a device according to the present invention.

FIGS. 6a and 6b are schematically illustrated block diagrams of devices according to the present invention that are configured to control polarized light.

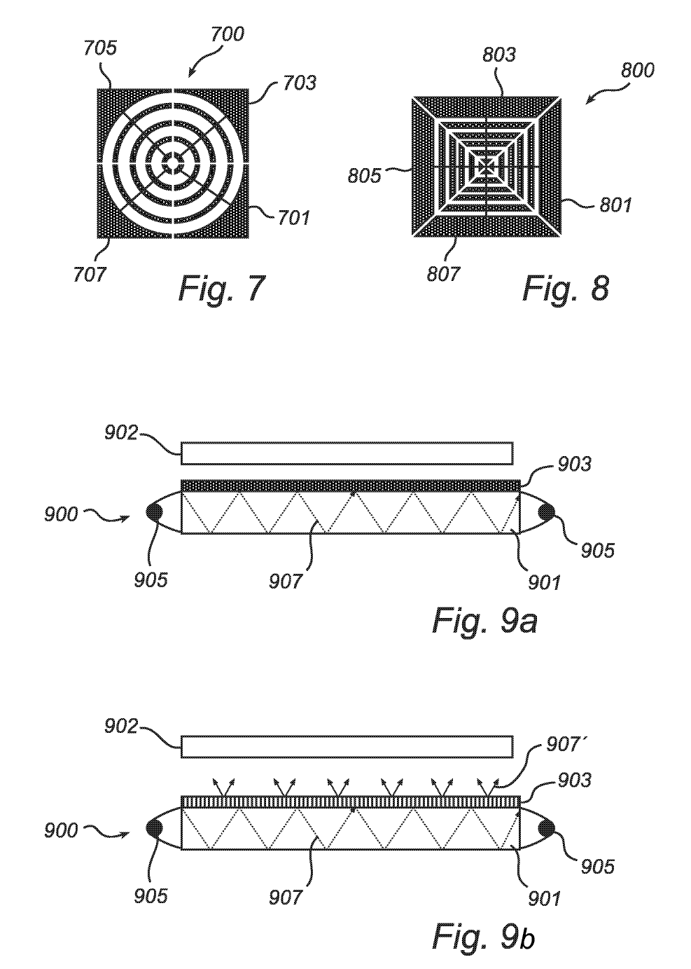

FIGS. 7 and 8 are schematically illustrated top views of electrode patterns of a device according to the present invention.

FIGS. 9a and 9b are schematically illustrated cross sectional views of a system according to the present invention.

Turning now to FIG. 1, a cross section of a lighting system 100 is shown centered around an optical axis 105. The system 100 comprises a light source 107 that emits light, as indicated by light rays 109 and 111, and a device for controlling shape and direction of light 101 having a spatial extent as defined by a radius r. The light 109, 111 is controlled by the device for controlling shape and direction of light 101 in such a manner that both direction and collimation may be affected. In FIG. 1 this is illustrated by the light rays 109′ and 111′ being collimated to a focus as defined by a focal length f along the optical axis 105. An angle θ defines the divergence of the light rays 109′, 111′ and, as the skilled person will realize, by changing the focal length f the divergence θ is changed according to the simple relation: tan(θ)=r/f. A deflection angle α is also indicated, which will be discussed below in connection with FIG. 5.

As will be described further below, the device for controlling shape and direction of light 101 uses a controller 103 having input means 141 to adjust the characteristics of the device for controlling shape and direction of light 101. The input means 141 may in a simple implementation be in the form of buttons or keys that enable a user to adjust a voltage level or several voltage levels, for example in accordance with an AC frequency. As the skilled person will realize, the input means 141 and the controller may be integrated into more or less intelligent circuitry and also be incorporated in, or connected to, a control computer and the like.

Turning now to FIGS. 2a, 2b and 2c, a more detailed description will be made of a device for controlling shape and direction of light 201. FIGS. 2a and 2b are cross sectional views in the xz-plane as indicated by a section AA in the xy-plane in FIG. 2c. The device 201 comprises a transparent first substrate 203 and a transparent second substrate 205 separated by a distance d. The substrates 203, 205 may be made of a suitable glass material. A first electrode pattern 207 and a second electrode pattern 217 is arranged on the first 203 and the second 205 substrate, respectively, and a layer of liquid crystal material 209 is arranged between the two substrates 203, 205. As the skilled person will realize, orientation layers (not shown) for orienting the molecules of the liquid crystal material along a preferred common direction may also be arranged between the substrates 203, 205. Such orientation layers have been omitted in order not to clutter the description unnecessarily.

As illustrated in FIG. 2c, the electrode pattern 207 has a hexagonal structure with a typical spatial scale 2R of 40 μm. The second electrode pattern 217, although not visible in FIG. 2c, has the same hexagonal structure as the pattern of the first electrode 207 and is aligned with the first electrode pattern 207 in the xy-plane.

Light 211 from a light source (not shown) is transmitted through the device 201 and exits as indicated by light 211′. FIG. 2a illustrates a situation in which no electric potential difference is present between the two electrode patterns 207, 217 as schematically illustrated by a zero voltage across electrode terminals 231 and 232 connected to the respective electrode patterns 207 and 217. In the absence of an electric field, i.e. zero potential difference between the electrodes 207, 217, the molecules of liquid crystal material 209 are aligned along a common direction (here the x-direction) as governed by orientation layers (not shown).

FIG. 2b illustrates a situation in which a non-zero electric potential difference is present between the two electrode patterns 207, 217. Electric field gradients are thereby induced between the electrode patterns 207, 217 causing gradients in the orientation of the molecules of the liquid crystal material as indicated by reference numeral 213. In turn, the gradients in the orientation of the molecules of the liquid crystal material results in an effective gradient in the refractive index of the liquid crystal material.

In order to fine-tune the refractive index distribution within the liquid crystal for obtaining a better control over the light beam it might also be desirable to place a layer with high surface resistance on top of the patterned electrode/s. In this way the frequency of an applied voltage can also be used in getting an improved refractive index gradient for an improved beam shape. FIG. 2d is a cross section of a patterned electrode (such as the electrode 207 in FIGS. 2a and 2b) placed on top of a substrate (such as the substrate 205) and covered with a layer 220 having a high surface resistance.

An array of micro-lenses has thus been obtained, capable of shaping the incoming light 211 into transmitted light 211′, by changing the applied electric potential difference U between the electrode patterns 207, 217. The focal length f of such a micro lens array may be expressed as: f=r²/(2*Δn*d), where Δn is the induced refractive index difference.

FIG. 3 illustrate experimental measurements for the focal length f and the divergence θ of such a micro lens array as a function of applied voltage difference between the electrodes 207 and 217 in FIG. 2. As can be seen, at least in the voltage difference interval 4-7 V, the focal distance decreases with increased voltage difference and the divergence increases with increased voltage difference.

FIG. 4 illustrates experimental measurements for the distribution of light beam intensity as a function of divergence angle θ at different applied voltage differences between the electrodes 207 and 217 in FIG. 2. As can be seen, at a voltage difference U=0V, the FWHM for the light beam is around 9 degrees, at U=4V the FWHM is about 16 degrees and at U=6V the FWHM is about 14 degrees.

Turning now to FIG. 5, another embodiment of a device for controlling shape and direction of light 501. Similar to FIGS. 1, 2a and 2b, FIG. 5 is a cross sectional view in an xz-plane. The device 501 comprises a transparent first substrate 503 and a transparent second substrate 505. The substrates 503, 505 may be made of a suitable glass material. A first electrode pattern 507 comprising a plurality of electrode segments 507a, 507b, 507c etc. and a second, more or less featureless, electrode 509 connected to ground 511 are arranged on the first 503 and the second 505 substrate, respectively. A layer of liquid crystal material is arranged between the two substrates 503, 505 and is indicated by reference numeral 506.

A controller 513 is configured to control the application of voltage differences between the first electrode pattern 507 and the second electrode 509. By applying a first voltage difference U₁ between the first segment 507a of the first electrode 507 and the second electrode 509, a second voltage difference U₂ between the second segment 507b of the first electrode 507 and the second electrode 509 etc., a distribution of refractive index along the x direction is obtained as illustrated in the diagram above the device 501 in FIG. 5.

When transmitted through the device 501, light (not shown in FIG. 5) incident along the z-direction will be deflected an angle α (cf. FIG. 1) as well as affected with respect to focal length and divergence as discussed above.

Turning now to FIGS. 6a and 6b, devices 601, 651 according to the invention will be described that are configured to control the shape and direction of polarized light. In FIG. 6a a device 601 for controlling shape and direction of light comprises a first element 611 and a second element 613. These elements 611, 613 may be in the form of any of the devices described above, in which the liquid crystal material is oriented along a first orientation direction as indicated by the arrow 612 and a second orientation direction as indicated by arrow 614, respectively. Although not shown in FIG. 6a, each of the elements comprises electrodes as well as a controller as the previously described devices or may be configured to be controlled by one common controller, as the skilled person will realize.

As FIG. 6a shows, the first orientation direction 612 and the second orientation direction 614 are essentially perpendicular. This means that incident light 621 that comprises non-significant fractions of light polarized in each of the two orientation directions 612, 614 can be controlled without unnecessary losses. That is, the fraction of light that is polarized along the first orientation direction 612 is controlled by the first element 611 and the fraction of light that is polarized along the second orientation direction 614 is controlled by the second element 613, yielding a light beam 621′ comprising most of the incident light 621. Hence, effectively no light passes the device 601 without being controlled.

An alternative embodiment is shown in FIG. 6b. Here a device 651 for controlling shape and direction of light comprises a first element 611 and a second element 615. These elements 611, 615 may be in the form of any of the devices described above, in which the liquid crystal material is oriented along one and the same first orientation direction as indicated by the arrows 612 and 616. As above, the elements 611, 615 comprise controllable electrodes. A half wave plate 617 is arranged between the elements 611 and 615.

As FIG. 6b shows, the first orientation direction 612 and the second orientation direction 616 are essentially parallel. The incorporation of the half wave plate 617 means that incident light 621 that comprises non-significant fractions of light polarized in the orientation direction 612 as well as any fraction of light that is polarized in a direction perpendicular to the orientation direction 612 (cf. FIG. 6a) can be controlled without unnecessary losses. That is, the fraction of light that is polarized along the first orientation direction 612 is controlled by the first element 611 and the fraction of light that is polarized along a perpendicular orientation direction is controlled by the second element 615 after being rotated, in the half wave plate 617, by 45 degrees as indicated by the direction of arrow 618, yielding a light beam 621′ comprising most of the incident light 621. Hence, effectively no light passes the device 601 without being controlled.

FIG. 7 illustrates one alternative embodiment of an electrode pattern 700 comprising four electrode segments 701, 703, 705 and 707. The electrode pattern 700 may be incorporated in a device for controlling shape and direction of light such as any of the devices described above.

FIG. 8 illustrates yet an alternative embodiment of an electrode pattern 800 comprising four electrode segments 801, 803, 805 and 807. The electrode pattern 800 may be incorporated in a device for controlling shape and direction of light such as any of the devices described above.

By applying different voltages to the segments of the electrode patterns 700, 800, more complex and accurate control of a light beam may be achieved.

One application in which a device as described above may be used is in a lighting system, e.g., for use in a computer display environment. Such a lighting system 900 is schematically illustrated in FIGS. 9a and 9b. The system 900 comprises a light guide 901 into which light 907 is provided by light sources 905, a display screen 902 that is configured to be lit by out coupled light 907′ from the light guide 901. The out coupling of light from the light guide 901 is performed by means of a device 903 for controlling shape and direction of light having patterned electrodes where the pattern preferably has the form of a ruled grating.

FIG. 9a illustrates a situation in which the device 903 is controlled not to out couple light from the light guide 901 and in FIG. 9b, the device 903 is controlled to out couple light 907′.

Although some indications have been given above with regard to the spatial dimensions, the following summarizes some preferred dimensions regarding the electrode patterns and the distances between the electrode carrying substrates. It is to be noted, however, that these dimensions are not principal but practical restrictions regarding cost and yield and performance.

For example, ITO patterns is preferably scaled at a typical dimension of 5 μm. Very unlikely below 1 μm or above 10 μm. This due to the fact that below 1 μm, these patterns are difficult to produce and above 10 μm light is not influenced and in this scale also high losses are of consequence.

The cell gap, i.e. the distance between substrates, will be most likely around 20 μm. Very unlikely below 5 μm or above 50 μm. This is due to the cost of liquid crystal material, low switching speed of the cell at high cell gap.

The smallest distance between individual ITO patterns is typically 50 μm. Most unlikely below 10 μm or above 100 μm. Below 10 μm it becomes difficult to induce a lens action and with distances above 100 μm weak lenses with small light controlling effect are obtained.

As the skilled person will realize, all components making up the devices described above are further brought into optical contact by liquid or resin in order to minimize reflection losses at interfaces. The conductive layers with high reflection losses are minimized by making them as thin as possible in order to reduce reflection losses.

Moreover, by using appropriate materials for the substrate, liquid crystal and electrodes, a total transmission in the wavelength range 500 mm-800 mm is obtained that is higher than 80%.

In double cell configuration it is also important to align the cells with respect to each other in order to avoid Moirè effects. Moirè effect can appear upon application of voltage across the cells and can cause the intensity distribution of the light to be ununiform with local minima and maxima.

1. A device (100, 201, 501, 601, 651) for controlling shape and direction of light, comprising:
a first transparent planar substrate (203, 503) and a second transparent planar substrate (205, 505), the substrates being configured for arrangement essentially perpendicular to incident light beams (211),
a liquid crystal layer (209, 506) arranged between the first and second substrate,
a first transparent electrode pattern (207, 507, 700, 800) arranged on the first substrate and a second transparent electrode pattern (217, 509, 700, 800) arranged on the second substrate, and
control means (103, 513) configured to adjust an electric potential difference between the first and second electrode patterns, thereby configured to adjust a refractive index of the liquid crystal layer.

2. The device according to claim 1, where the control means are configured to adjust the potential difference in accordance with an AC frequency.

3. The device according to claim 1, where the first electrode pattern is essentially identical to the second electrode pattern.

4. The device according to claim 1, where any of the first electrode pattern and the second electrode pattern (207) comprises a plurality of hexagonal features.

5. The device according to claim 1, where any of the first electrode pattern (700, 800) and the second electrode pattern (700, 800) comprises a plurality of electrode segments (701, 703, 705, 707, 801, 803, 805, 807), each segment being configured to be individually adjusted with respect to electric potential.

6. The device according to claim 1, where any one of the first electrode pattern and the second electrode pattern is substantially featureless.

7. The device according to claim 1, where any of the first electrode pattern and the second electrode pattern is coated with a layer (220) having a high surface resistance.

8. The device according to claim 1, where the electrode patterns comprise features of spatial dimensions essentially in the interval 1-10 μm.

9. The device according to claim 1, where the electrode patterns covered by a non-conducting or high surface resistance layer comprise features of spatial dimensions essentially in the interval 10-100 μm.

10. The device according to claim 1, where the first substrate and the second substrate are separated by a distance in the interval 5-50 μm.

11. The device according to claim 1, where the electrodes are made of Indium Tin Oxide.

12. The device according to claim 1, where total transmission in the wavelength range 500 nm-800 nm is higher than 80%.

13. The device according to claim 1, where the controller is configured to adjust the electric potential difference between the first and second electrode patterns in the interval 0-20V.

14. A device (601, 651) for controlling shape and direction of light, comprising a first device (611) according to claim 1 in which the liquid crystal material is aligned along a first direction of orientation (612), a second device (613) according to claim 1 in which the liquid crystal material is aligned along a second direction of orientation (614).

15. The device according to claim 14, where said first direction of orientation is essentially perpendicular to said second direction of orientation.

16. The device according to claim 14, where said first direction of orientation is essentially parallel to said second direction of orientation, further comprising a half wave plate (617) arranged between said first and second devices.

17. The device according to claim 14, where the first and the second devices are arranged so as to avoid appearance of local maxima and minima in the intensity of transmitted light.

18. A lighting system (900) comprising a device according to claim 1 and at least one light source (107, 905).

19. The lighting system according to claim 18, where the at least one light source comprises at least one light emitting diode emitting light having at least one color.
